(19) United States
(12) Patent Application Publication
(10) Pub. No.: US 2011/0057585 A1
(43) Pub. Date: Mar. 10, 2011

(54) SYSTEM FOR REALIZING ROTOR VARIABLE FREQUENCY SPEED CONTROL ASYNCHRONOUSLY AND SIMULTANEOUSLY BY DRIVING FOUR MOTORS VIA ONE INVERTER

(76) Inventor: Shunxin Zhou, Wuhan city (CN)

(21) Appl. No.: 12/991,411

(22) PCT Filed: Jun. 6, 2008
(86) PCT No.: PCT/CN2008/001105

§ 371 Date: Nov. 9, 2010

(30) Foreign Application Priority Data
May 6, 2008 (CN) 200810094147.6

(51) Int. Cl. H02P 5/00

(52) U.S. Cl. 318/67

(57) ABSTRACT

The present invention discloses a system for realizing rotor variable frequency speed control asynchronously, which drives a plural of motors via one inverter. This system is consisted of a motor group, a rectifier group, a current limiter group, a chopper group, an isolator group, an active inverter, an A/D converter group, a signal processor group, a current detector group and a voltage detector group. By employing inversion control theory and CPU control technology, a plural of motors are controlled on line, the voltage output by one inverter is used as the additional inverse electromotive force of each motor, and each chopper is effectively turned on and turned off via a PWM signal which is output by each driver, so that four jobs of a crane, lifting, luffing, revolving and walking, can be realized. By the present invention, the circuit is simplified, the size is reduced, the cost is lowered, and the reliability is improved. When the crane rises, redundant electric energy will always be fed back to the motor via the same inverter, and when the crane falls, the motor will be in generator state, and the electric energy generated will be again fed back to the motor or the electric network via the same inverter, thereby realizing energy recovery and saving the energy source.

### FIELD OF THE INVENTION

The present invention relates to motor rotor variable frequency speed control systems, and in particular, to a system for realizing rotor variable frequency speed control asynchronously and simultaneously by driving four motors via one inverter.

### BACKGROUND OF THE INVENTION

Motor is the prime mover in each operating mechanism of a crane. It converts electric energy into mechanical energy to drive the crane to perform four different mechanism movements, lifting (or falling), luffing, revolving and walking, thereby accomplishing the field operation task of the crane.

FIG. 1 is a schematic diagram showing a traditional system for a crane to realize variable frequency speed control using motors for different jobs. It can be seen from the figure that, the system converts the constant voltage constant frequency AC power supply provided by an electric network into DC power supply via a rectifier bridge, and then converts the DC power supply, by an intermediate circuit, into AC power supply of different working frequencies via an inverter bridge, so as to drive the motor to rotate.

It is supposed that: the frequency of the electric network power supply is fₒ, and the working frequency of the motor is fₘ,

Then, fₘ=§fₒ is true,

Here, § is slip ratio.

During the field operation of a crane, it usually requires four different operations, lifting, luffing, revolving and walking. Therefore, each corresponding actuating mechanism needs a different motor to provide different electric energy that will be converted to a different mechanical energy. In other words, during different operations of the crane, the motor rotating speed needed is different, that is, the working frequency fₘ of the motor is different. However, in the traditional motor variable frequency speed control system, one inverter bridge can only convert the working frequency of one motor and carry out variable frequency speed control on one motor, which is so called “one-driving-one” technology. Apparently, for the four different operations of the crane, four inverter bridge circuits are required to realize “AC-DC-AC” conversion during which transduction is performed twice. Thus, the respective working frequency needed by the four motors will be generated, so that the lifting, luffing, revolving and walking operation during the field operation of the crane will be accomplished respectively.

In conclusion, for the above traditional motor speed control system, its frequency adjustment range is broad, and it will not be limited by the frequency of the electric network; not only forced transduction, but also load transduction, may be employed. For such a speed control system, in addition that the loss of slipping function is great and the efficiency is low at low speed, most prominently, four inverter bridges are required, thus the system will be bulky, massy and costly, and it will be very difficult to implement.

In recent years, with the rapid development of frequency conversion technologies, especially with the application of vector control technologies and direct torque control technology, frequency conversion technology becomes increasingly mature, and it takes the leading position in AC transmission due to its broad speed control range, high steady speed precision, rapid dynamic response and its capability of reversible operation in the four quadrants of the rectangular axis. Its speed control capability can completely matches that of DC transmission, and there appears a tendency that DC transmission is being replaced by it. However, in the frequency conversion technologies employed by overseas jack mechanisms, it still uses one frequency converter for one function, and one inverter bridge is equipped for one frequency converter; for the four functions during the normal operation of a crane, four inverter bridges are still needed. If energy feedback function is to be added to the variable frequency speed control system, another four inverter bridges need to be added, which is nonpaying apparently. Therefore, for the related products of many overseas companies, “one-driving-one” mode is still employed to accomplish the normal operation of a crane, for example, products such as YASKAWA (Japan), Siemens (Germany), ABB (Switzerland) and Schneider (France), which can be seen everywhere in related application field in China, and of which the prices are very high.

Directed to the serious faults of the above existing frequency conversion technologies, patent applications have been filed successively by the inventor, and three utility model patents have been granted by State Intellectual Property Office of the People's Republic of China, with the Patent Number of “ZL 00232436.9”, “ZL 0 121224.5” and “ZL200720087085.7” respectively. These three utility model patents first disclose an active inverter with multiple motors; during operation, the inverter is positioned at the minimum inverse angle, and rotor variable frequency speed control is realized via the turnon and turnoff of each chopper, so that four jobs, lifting, luffing, revolving and walking, can be accomplished by the crane in real time. However, the above three utility model patents only put forward the basic concept of “one-driving-four” rotor variable frequency speed control; and problems, such as how to provide appropriate forward and inverse output control voltage to effectively turn on and turn off each chopper, and how to collect the rotor phase voltage and the rectifier output DC to rapidly establish a grid control electric field by the chopper so as to guarantee the normal and orderly work of the system, still need to be solved allsidedly.

### SUMMARY OF THE INVENTION

It is an object of the present invention to overcome the defects in the above prior art and provide a whole system for realizing rotor variable frequency speed control asynchronously and simultaneously by driving four motors via one inverter. In other words, during the online control on four motors, the voltage output by one and the same active inverter is taken as the additional inverse electromotive force of each functional motor to drive the real-time work of each functional chopper, thereby realizing the asynchronous and simultaneous operation of four motors. Moreover, the system according to the invention should also have an energy feedback and recycle function, so that the energy source may be saved effectively.

To attain the above object, the invention employs the following technical solutions:

A system for realizing rotor variable frequency speed control asynchronously and simultaneously by driving four motors via one inverter, comprising:

a motor group, which has four motors, M₁, M₂, M₃ and M₄, for asynchronously and simultaneously accomplishing four jobs of a crane, lifting, luffing, revolving and walking;

a rectifier group, which comprises four rectifier bridges, Z₁, Z₂, Z₃ and Z₄, for rectifying AC signals with different frequencies provided by motor rotors connected therewith;

a current limiter group, which comprises four current limiters, L₁, L₂, L₃ and L₄, for providing an instantaneous current to make a chopper work normally;

a chopper group, which comprises four choppers, IGBT₁, IGBT₂, IGBT₃ and IGBT₄, for realizing the continuous adjustment of a DC current by adjusting the conductive rate of each chopper and thus continuously adjusting the motor rotor current, so as to attain the object of motor rotor variable frequency speed control; it must be noted that, when the conductive rate of the chopper is 100%, the motor rotating speed will be the rotating speed;

an isolator group, which comprises four isolators, D₁, D₂, D₃ and D₄, for maintaining the continuity and guaranteeing the normal work of the motor rotor at minimum working current;

an active inverter, which, after rectifying the AC with different frequency output by each motor rotor to a DC, is adapted to invert the DC to an AC with the same power frequency as the electric network power supply, realize the conversion of AC to DC and DC to AC, and feed back the energy to the motor or the electric network;

a driver group, which comprises four drivers selecting EX841 integrated circuits, EX841-1, EX841-2, EX841-3 and EX841-4 in turn, which are all controlled by the master program of a microprocessor CPU, for performing pulse-width modulation, outputting a PWM signal, sending it to the grid of the corresponding chopper, so as to reliably turn on and turn off each chopper in real time;

a microprocessor CPU, the task of which is determined by the master program, for receiving a digital signal from each A/D converter, performing data processing and sending it to the corresponding drive circuit in turn, so as to control the task of the chopper in real time;

an A/D converter group, which comprises four A/D converters, A/D-1, A/D-2, A/D-3 and A/D-4, for converting each corresponding analogue signal into a digital signal needed;

a signal processor group, which comprises four signal processors, U₁, U₂, U₃ and U₄, for comprehensively processing each corresponding voltage, current detecting signal and the main command signal given by the motorman, and sending them to the corresponding A/D converter respectively;

a current detector group, which comprises four current detectors, U_{I1}, U_{I2}, U_{I3} and U_{I4} and lies on the path through which the current limiting inductive current contained in the above rectifier bridge passes, for detecting the DC current after being limited by each corresponding current limiter, converting it into voltage form and sending it to the input terminal of the corresponding signal processor; and

a voltage detector group, which comprises four voltage detectors Uv₁, Uv₂, Uvₐ and Uv₄ and lies between any two wires of the above motor rotor, for detecting the AC voltage with different frequencies between any two wires of each motor, converting it into a DC voltage, and sending the DC voltage to the input terminal of the corresponding signal processor.

In the invention, when online control is carried out multiple motors using inversion control theory technology, the voltage output by one and the same active inverter is taken as the additional inverse electromotive force of each functional motor, and asynchronous and simultaneous operation of multiple motors is realized via the real-time work of the chopper of each functional motor. Thus, for the whole system, the circuit is simplified, the size is reduced, the cost is lowered, and the reliability is improve, so that the stability, security and reliability of the field operation of a crane, lifting, luffing, revolving and walking, can be guaranteed.

In the invention, during the rising speed adjustment of the crane, based on that the motor rotor is connected to an active inversion system, redundant electric energy is always fed back to the motor or the electric network via the same inverter; but, during the falling operation of the crane, DC excitation is input to the two phase of the motor stator, thus the motor actually becomes a generator, and it is in power generation state, and moreover, the electric energy generated is again fed back to the motor or the electric network via the same inverter, so that energy recovery is realized, and energy source is saved effectively.

In the invention, by employing CPU control technology, the phase voltage of each motor rotor collected, the rectifier DC and the main command voltage given by the motorman is comprehensively processed in real time under the control of its master program, and the work of each driver is promoted in time, so that the effective turnon and turnoff of each chopper may be controlled, and motor rotor variable frequency speed control may be realize. By employing CPU control technology, automatic protection, state display and man-machine conversation may also be performed on overload limitation, failure monitoring, overspeed limitation, position restriction phase failure and undervoltage, overcurrent and wind velocity of the crane by adding an auxiliary circuit and in conjunction with appropriate software support, thus highly intellectualized and real-time control can be realized.

In the invention, by selecting EX841 integrated circuit as the driver of the switching device of a chopper, the power of the digital impulse signal output by the CPU may be amplified, a PWM control signal may be generated, thus effective and reliable work of the chopper may be ensured. At the same time, undervoltage and overcurrent protection is also set inside the integrated circuit, thus normal operation of the system may be guaranteed.

In fact, the chopper switching device in the invention is selected according to the rated power of the motor. Therefore, the control part of the chopper also has applicability, which can make the chopper rapidly establish a grid control electric field, thereby guaranteeing the normal, orderly and reliable work of the system.

### BRIEF DESCRIPTION OF THE DRAWINGS

FIG. 1 is a schematic diagram showing a traditional system for a crane to realize variable frequency speed control using motors for different jobs; and

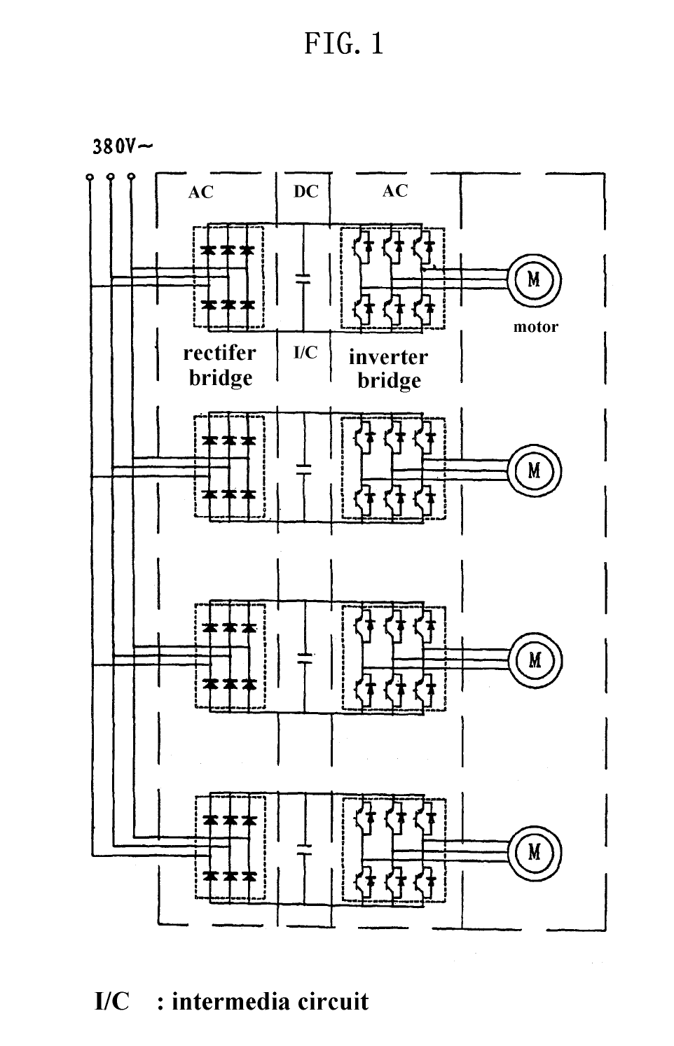

FIG. 2 is a schematic diagram showing the electrical principle wiring of the system for realizing rotor variable frequency speed control asynchronously and simultaneously by driving four motors via one inverter according to the invention.

### DESCRIPTION OF SYMBOLS IN THE DRAWINGS

1: Motor Group: M₁, M₂, M₃ and M₄
2: Rectifier Group: Z₁, Z₂, Z₃ and Z₄
3: Current limiter Group: L₁, L₂, L₃ and L₄
4: Chopper Group: IGBT₁, IGBT₂, IGBT₃ and IGBT₄
5: Isolator Group: D₁, D₂, D₃ and D₄
6: Active Inverter
7: Driver Group: EX841-1, EX841-2, EX841-3 and EX841-4
8: Microprocessor CPU
9: A/D Converter Group: A/D-1, A/D-2, A/D-3 and A/D-4
10: Signal Processor Group: U₁, U₂, U₃ and U₄
11: Current Detector Group: U_{I1}, U_{I2}, U_{I3} and U_{I4}
12: Voltage Detector Group: Uv₁, Uv₂, Uvₐ and Uv₄

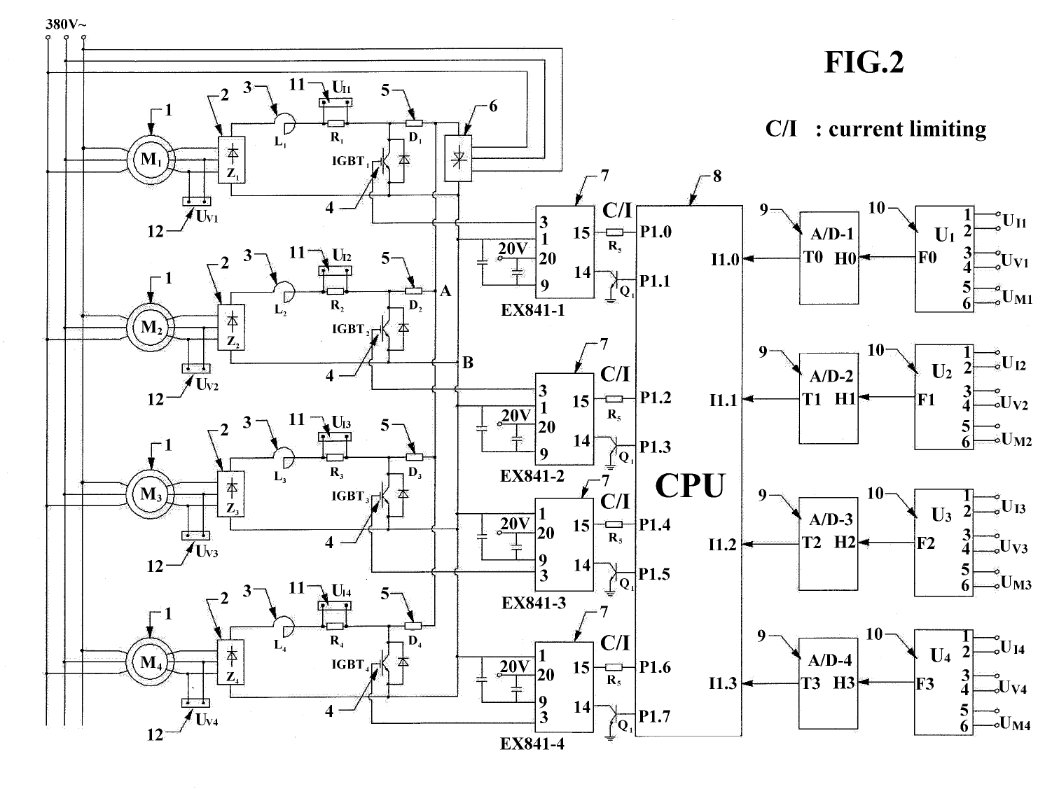

In addition, UM₁, UM₂, UM₃ and UM₄ in FIG. 2 are the main command voltages of the four jobs, lifting, luffing, revolving and walking, of a crane in field operation, respectively.

### DETAILED DESCRIPTION OF THE EMBODIMENTS

Referring to FIG. 2, it is one specific embodiment of the invention.

It can be seen from FIG. 2 that the system of the invention is consisted, as a whole, of motor group1, rectifier group 2, current limiter group 3, chopper group 4, isolator group 5, active inverter 6, driver group 7, microprocessor 8 (CPU), A/D converter group 9, signal processor group 10, current detector group 11 and voltage detector group 12, wherein:

The respective rotors of motors M₁, M₂, M₃ and M₄ in motor group 1 are connected to the respective corresponding input terminals of rectifiers Z₁, Z₂, Z₃ and Z₄ in rectifier group 2 in turn, respectively;

The output terminal of inverter 6 and the respective stators of motors M₁, M₂, M₃ and M₄ in motor group 1 are simultaneously connected to the same constant voltage constant frequency 380V AC electric network power supply;

The respective cathodes of choppers IGBT₁, IGBT₂, IGBT₃ and IGBT₄ in chopper group 4 intersect and connect at one point, i.e., point B;

The respective output terminals of isolators D₁, D₂, D₃ and D₄ in isolator group 5 intersect and connect at one point, i.e., point A;

The respective output terminals of current limiters L₁, L₂, L₃ and L₄ in current limiter group3 are connected with the corresponding input terminals of current detecting resistors R₁, R₂, R₃ and R₄ in current detector group 11 in turn respectively, while the output terminal of the above each current detecting resistor R₁, R₂, R₃ and R₄ is connected with the corresponding anode of choppers IGBT₁, IGBT₂, IGBT₃ and IGBT₄ in chopper group 4 and the corresponding input terminal of isolators D₁, D₂, D₃ and D₄ in isolator group 5 in turn;

The third pins of drivers EX841-1, EX841-2, EX841-3 and EX841-4 in driver group 7 are directly connected with the grid of choppers IGBT₁, IGBT₂, IGBT₃ and IGBT₄ in chopper group 4 in turn, respectively; while the first pin of each driver and the cathode of its corresponding chopper directly intersect and connect at one point, i.e., point B, in turn, respectively; the fifteenth pin of each driver is respectively connected with pin P1.0, P1.2, P1.4 and P1.6 of the CPU of microprocessor 8 in turn, via the current limiting resistor R in each path; the fourteenth pin of each driver is connected with the collector of the emitter follower Q1 set between pins P1.1, P1.3, P1.5 and P1.7 of the CPU of microprocessor 8; and a 47MF capacitor is connected between the first pin and the ninth pin of each driver, for absorbing the supply voltage change due to the power supply connection impedance, and it is not a power supply filter capacitor;

Pins P1.1, P1.3, P1.5 and P1.7 of the CPU of microprocessor 8 are connected, in turn, with the base of the emitter follower Q1 that is set between drivers EX841-1, EX841-2, EX841-3 and EX841-4 in driver group 7;

The resistances of current detecting resistors R₁, R₂, R₃ and R₄ in current detector group 11 are equal to each other, the current limiting DCs I2, I3 and I4 passing through are different, and the DC voltages UIᵢ, UI₂, UI₃ and UI₄ converted are also different; moreover, each voltage is connected to the first pin and the second pin of the input terminals of the corresponding signal processors U₁, U₂, U₃ and U₄ in signal processor group 10 in turn, respectively;

Voltage detector group 12 takes any two-phase phase voltage Uv₁, Uv₂, Uvₐ and Uv₄ on the rotors of motors M₁, M₂, M₃ and M₄ in motor group 1 in turn, and each voltage is connected to the third pin and the fourth pin of the input terminals of the corresponding signal processors U₁, U₂, U₃ and U₄ in signal processor group 10 in turn, respectively; while the main command voltages UM₁, UM₂, UM₃ and UM₄ given by the motorman are connected to the fifth pin and the sixth pin of the input terminals of the corresponding signal processors U₁, U₂, U₃ and U₄ in signal processor group 10 in turn, respectively;

The respective output terminals Fₒ, F₁, F₂ and F₃ of signal processors U₁, U₂, U₃ and U₄ in signal processor group 10 are directly connected with the respective input terminals H₀, H₁, H₂ and H₃ of converters A/D-1, A/D-2, A/D-3 and A/D-4 in A/D converter group 9 in turn, respectively;

The respective input terminals Hₒ, H₁, H₂ and H₃ of converters A/D-1, A/D-2, A/D-3 and A/D-4 in A/D converter group 9 are connected directly;

The respective output terminals T₀, T₁, T₂ and T₃ of converters A/D-1, A/D-2, A/D-3 and A/D-4 in A/D converter group 9 are directly connected with input terminals I1.0, I1.1, I1.2 and I1.3 of the CPU of processor 8 in turn, respectively.

The above embodiment only illustrates the technical characteristics and implementability of the invention. It must be noted that, in addition to being used by a crane to perform the above four different mechanism movements, lifting, luffing, revolving and walking so as to accomplish the field operation task, the invention may also be applicable for any place where multiple motors need to be driven to asynchronously and simultaneously realize a real-time work, for example, the control on different temperature and humidity in each weaving workshop of weaving industry; control on different flow and flow rate in each hydraulic power station; steel plate hoisting and splicing, component hole riveting, hull moving and overturning, weight float welding in shipbuilding industry; block hoisting of large-scale buildings and block erection of petrochemical equipment. Therefore, any circuitry or control method employed with well-known skills will be in the spirit of the invention. The characteristics of the invention will be defined by the appended claims and their equivalents.

1. A system for realizing rotor variable frequency speed control asynchronously and simultaneously by driving four motors via one inverter, consisted, as a whole, of motor group (1), rectifier group (2), current limiter group (3), chopper group (4), isolator group (5), active inverter (6), driver group (7), microprocessor (8), A/D converter group (9), signal processor group (10), current detector group (11) and voltage detector group (12), wherein:
the respective rotors of motors M₁, M₂, M₃ and M₄ in motor group (1) are respectively connected to the respective corresponding input terminals of Z₁, Z₂, Z₃ and Z₄ in rectifier group (2);
the output terminal of inverter (6) and the respective stators of motors M₁, M₂, M₃ and M₄ in motor group (1) are simultaneously connected to the same constant voltage constant frequency 380V AC electric network power supply;
the respective cathodes of choppers IGBT₁, IGBT₂, IGBT₃ and IGBT₄ in chopper group (4) simultaneously intersect and connect at one point, i.e., point B;
the respective output terminals of isolators D₁, D₂, D₃ and D₄ in isolator group (5) simultaneously intersect and connect at one point, i.e., point A;
wherein:
a. the third pins of drivers EX841-1, EX841-2, EX841-3 and EX841-4 in driver group (7) are directly connected with the grids of choppers IGBT₁, IGBT₂, IGBT₃ and IGBT₄ in chopper group (4) in turn, respectively;
b. the first pin of each driver in driver group (7) and the cathode of its corresponding chopper directly intersect and connect at one point in turn respectively, i.e., point B;
c. the fifteenth pin of each driver in driver group (7) is respectively connected with pins P1.0, P1.2, P1.4 and P1.6 of the CPU of microprocessor (8) in turn via the current limiting resistance R5 in each path; the fourteenth pin of each driver is connected with pins P1.1, P1.3, P1.5 and P1.7 of the CPU of microprocessor (8) via the emitter follower Q1 in each path; and
d. a 47MF capacitor is connected between the first pin and the ninth pin of the drivers in driver group (7).

2. The system for realizing rotor variable frequency speed control asynchronously and simultaneously by driving four motors via one inverter according to claim 1, wherein:
the fourteenth pins of drivers EX841-1, EX841-2, EX841-3 and EX841-4 are connected with the collector of the emitter follower Q1 set between pins P1.1, P1.3, P1.5 and P1.7 of the CPU of microprocessor (8) in turn.

3. The system for realizing rotor variable frequency speed control asynchronously and simultaneously by driving four motors via one inverter according to claim 1, wherein:
pins P1.1, P1.3, P1.5 and P1.7 of the CPU of microprocessor (8) are in turn connected with the base of the emitter follower Q1 set between drivers EX841-1, EX841-2, EX841-3 and EX841-4 in driver group (7).

4. The system for realizing rotor variable frequency speed control asynchronously and simultaneously by driving four motors via one inverter according to claim 1, wherein:
the respective output terminals of current limiters L₁, L₂, L₃ and L₄ in current limiter group (3) are connected with the corresponding input terminal of current detecting resistors R₁, R₂, R₃ and R₄ in current detector group (11) in turn, respectively; while the output terminals of current detecting resistors R₁, R₂, R₃ and R₄ are connected with the corresponding anode of choppers IGBT₁, IGBT₂, IGBT₃ and IGBT₄ in chopper group (4) and the corresponding input terminal of isolators D₁, D₂, D₃ and D₄ in isolator group (5).

5. The system for realizing rotor variable frequency speed control asynchronously and simultaneously by driving four motors via one inverter according to claim 1, wherein:
the resistances of current detecting resistors R₁, R₂, R₃ and R₄ in current detector group (11) are equal to each other, the current limiting DCs I₁, I₂, I₃ and I₄ passing through are different, and the DC voltage UI₁, UI₂, UI₃ and UI₄ converted are also different.

6. The system for realizing rotor variable frequency speed control asynchronously and simultaneously by driving four motors via one inverter according to claim 5, wherein:
the DC voltages UI₁, UI₂, UI₃ and UI₄ converted according to the currents Iᵢ, I₂, I₃ and I₄ passing through current detecting resistors R₁, R₂, R₃ and R₄ in current detector group (11) are connected to the first pin and the second pin of the input terminals of the corresponding signal processors U₁, U₂, U₃ and U₄ in signal processor group (10) in turn, respectively.

7. The system for realizing rotor variable frequency speed control asynchronously and simultaneously by driving four motors via one inverter according to claim 1, wherein:
voltage detector group (12) takes any two-phase phase voltage Uᵥ₁, Uᵥ₂, Uᵥ₃ and Uᵥ₄ on the rotors of motors M₁, M₂, M₃ and M₄ in motor group (1) in turn, and each voltage is connected to the third pin and the fourth pin of the input terminals of the corresponding signal processors U₁, U₂, U₃ and U₄ in signal processor group (10) in turn, respectively.

8. The system for realizing rotor variable frequency speed control asynchronously and simultaneously by driving four motors via one inverter according to claim 1, wherein:
the main command voltages U_{M1}, U_{M2}, U_{M3} and U_{M4} given by the motorman are connected to the fifth pin and the sixth pin of the input terminals of the corresponding signal processors U₁, U₂, U₃ and U₄ in processor group (10) in turn, respectively.

9. The system for realizing rotor variable frequency speed control asynchronously and simultaneously by driving four motors via one inverter according to claim 1, wherein:
the respective output terminals Fₒ, F₁, F₂ and F₃ of signal processors U₁, U₂, U₃ and U₄ in signal processor group (10) are directly connected with the respective input terminals Hₒ, H₁, H₂ and H₃ of converters A/D-1, A/D-2, A/D-3 and A/D-4 in A/D converter group (9) in turn, respectively.

10. The system for realizing rotor variable frequency speed control asynchronously and simultaneously by driving four motors via one inverter according to claim 1, wherein:
the respective output terminals T₀, T₁, T₂ and T₃ of converters A/D-1, A/D-2, A/D-3 and A/D-4 in A/D converter group (9) are directly connected with input terminals I1.0, I1.1, I1.2 and I1.3 of the CPU of microprocessor (8) in turn, respectively.
